(19) United States
(12) Patent Application Publication
(10) Pub. No.: US 2022/0215288 A1
(43) Pub. Date: Jul. 7, 2022

(54) TRAINING SYSTEM AND TRAINING METHOD OF REINFORCEMENT LEARNING

(71) Applicant: Institute For Information Industry, Taipei (TW)

(72) Inventors: Yen-I OUYANG, Taipei (TW); Chin-Feng LAI, Taipei (TW); Chieh-Lin CHUANG, Taipei (TW); Chi-Hsuan LEE, Taipei (TW); Cheng-Ping TSENG, Taipei (TW); Wei-Zhong HSU, Taipei (TW)

(21) Appl. No.: 17/157,972

(22) Filed: Jan. 25, 2021

(30) Foreign Application Priority Data
Jan. 5, 2021 (TW) 110100312

(51) Int. Cl. G06N 20/00

(52) U.S. Cl. CPC G06N 20/00

(57) ABSTRACT

A training system and a training method of reinforcement learning are disclosed. The training system includes a first computer device and a second computer device, and the computing power of the second computer device is better than that of the first computer device. The first computer device stores a reinforcement learning model; receives input data; and feeds the input data into the reinforcement learning model to generate a first output result. The second computer device stores a supervised learning model; receives the input data from the first computer device; feeds the input data into the supervised learning model to generate a second output result; and transmits the second output result to the first computer device. The first computer device further generates reward data according to the first output result and the second output result, and trains the reinforcement learning model according to the reward data.

### PRIORITY

This application claims priority to Taiwan Patent Application No. 110100312 filed on Jan. 5, 2021, which is hereby incorporated by reference in its entirety.

### FIELD

Embodiments of the present invention relate to a training system and a training method. More specifically, embodiments of the present invention relate to a training system and a training method of reinforcement learning.

### BACKGROUND

The disadvantage of reinforcement learning is that the convergence speed will be slow when receiving insufficient reward (feedback) information during reinforcement learning. Therefore, there is a way to combine supervised learning and reinforcement learning to become the so-called supervised-assisted reinforcement learning, wherein the supervised learning can provide the reward information required for training a reinforcement learning model. However, with the introduction of the supervised learning, it usually requires a computer device with better computing power (e.g., a server) to realize the supervised-assisted reinforcement learning, thereby limiting its practical applications. In other words, a computer device with lower computing power (e.g., a terminal device) does not have the advantages of the traditional supervised-assisted reinforcement learning. Accordingly, how to enable a computer device with lower computing power to have the advantages of the traditional supervised-assisted reinforcement learning will be an important issue in the technical field of the present invention.

### SUMMARY

To solve at least the aforesaid problems, certain embodiments herein provide a training system of reinforcement learning. The training system may comprise a first computer device and a second computer device electrically connected to each other, where a computing power of the second computer device is better than a computing power of the first computer device. The first computer device may be configured to: store a reinforcement learning model; receive input data; and feed the input data into the reinforcement learning model to generate a first output result. The second computer device may be configured to: store a supervised learning model; receive the input data from the first computer device; feed the input data into the supervised learning model to generate a second output result; and transmit the second output result to the first computer device. The first computer device may be further configured to: generate reward data according to the first output result and the second output result, and train the reinforcement learning model according to the reward data.

To solve at least the aforesaid problems, certain embodiments herein provide a training method of reinforcement learning. The training method may comprise the following steps: receiving input data by a first computer device; feeding the input data into a reinforcement learning model by the first computer device to generate a first output result, wherein the reinforcement learning model is stored in the first computer device; transmitting the input data to a second computer device by the first computer device; feeding the input data into a supervised learning model by the second computer device to generate a second output result, wherein the supervised learning model is stored in the second computer device; transmitting the second output result to the first computer device by the second computer device; and generating reward data according to the first output result and the second output result and training the reinforcement learning model according to the reward data by the first computer device. In the training method, a computing power of the second computer device is better than a computing power of the first computer device.

The reinforcement learning model may be configured in a first computer device with lower computing power, and the supervised learning model is configured in a second computer device with better computing power. Through the configurations, the first computer device may be a relatively low-level device with lower computing power and capability, and instead of the first computer device, the high-efficiency computing may be processed by the second computer device with higher computing power and capability. By doing so, the reward insufficient problem of traditional reinforcement learning can be improved, and a computer device with low computing power can also take the advantages of the traditional supervised-assisted reinforcement learning because the amount of calculation is shared by two separate computer devices with different machine learning (i.e., the supervised learning model and the reinforcement learning model).

What described above are not intended to limit the present invention, but only generally describe the technical problems that can be solved by the present invention, the technical means that can be adopted by the present invention, and the technical effects that can be achieved by the present invention so that a person having ordinary skill in the art can preliminarily understand the present invention. The detailed technology and preferred embodiments implemented for the subject invention are described in the following paragraphs accompanying the appended drawings for a person having ordinary skill in the art to well appreciate the features of the claimed invention.

### BRIEF DESCRIPTION OF THE DRAWINGS

The attached drawings may assist in explaining various embodiments of the present invention, in which:

FIG. 1 illustrates a structure of a training system of reinforcement learning according to some embodiments of the present invention;

FIG. 2 illustrates operations of the training system of reinforcement learning shown in FIG. 1 according to some embodiments of the present invention; and

FIG. 3 illustrates a flow of a training method of reinforcement learning according to some embodiments of the present invention.

### DETAILED DESCRIPTION

In the following description, the present invention will be explained with reference to certain example embodiments thereof. However, these example embodiments are not intended to limit the present invention to operations, environments, applications, structures, processes, or steps described in these embodiments. For ease of description, contents unrelated to the embodiments of the present invention or contents that can be appreciated without particular description are omitted from depiction herein. In the attached drawings; dimensions of elements and proportional relationships among individual elements in the attached drawings are only exemplary examples but not intended to limit the present invention. Unless stated particularly, same (or similar) reference numerals may correspond to same (or similar) elements in the following contents. Unless otherwise specified, the number of each element described below may be one or more while being implementable.

Terms used in the present disclosure are only used to describe the embodiments, and are not intended to limit the present invention. Unless the context clearly indicates otherwise, singular forms “a” and “an” are intended to comprise plural forms as well. Terms such as “comprising” and “including” indicate the presence of stated features, integers, steps, operations, elements and/or components, but do not exclude the presence of one or more other features, integers, steps, operations, elements, components, and/or combinations thereof. The term “and/or” comprises any combinations of one or more associated listed items.

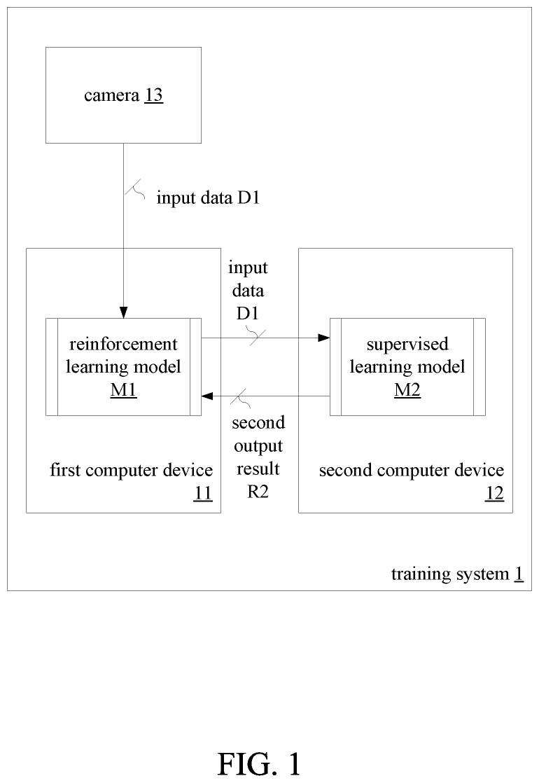

FIG. 1 illustrates a structure of a training system of reinforcement learning according to some embodiments of the present invention. However, the contents shown in FIG. 1 are only for illustrating embodiments of the present invention instead of limiting the scope of the claimed invention. Referring to FIG. 1, the training system 1 may comprise a first computer device 11 and a second computer device 12 electrically connected to each other. The first computer device 11 may store a reinforcement learning model M1. The second computer device 12 may store a supervised learning model M2. The connection between the first computer device 11 and the second computer device 12 may be a direct connection (i.e., not through other devices) or an indirect connection (i.e., through other devices).

Each of the first computer device 11 and the second computer device 12 may be implemented as a server, a notebook computer, a tablet computer, a desktop computer, or a mobile device. Each of the first computer device 11 and the second computer device 12 may comprise a processing unit (for example, a central processing unit, a microprocessor, and a microcontroller), a storage unit (for example, memory, hard disk, compact disk (CD), and plug-in storage, and cloud storage), and an input/output interface (for example, an Ethernet interface, an Internet interface, a telecommunication interface, and a USB interface). Each of the first computer device 11 and the second computer device 12 may individually perform various logical operations through its processing unit, and may individually store the results of the operations in its storage unit. The storage unit of each of the first computer device 11 and the second computer device 12 may individually store data generated by each of the first computer device 11 and the second computer device 12 itself and may also individually store various data which is input from the outside. The input/output interface of each of the first computer device 11 and the second computer device 12 may individually transmit and exchange data with various external devices.

The computing power of the second computer device 12 is better than the computing power of the first computer device 11. For example, the first computer device 11 may be a terminal device (such as a terminal device or an edge device at a terminal side), and the second computer device 12 may be a cloud device (such as a cloud server or a central server at a cloud side). In some embodiments, the second computer device 12 may also comprise a Radis Server. Through the Radis Server, the second computer device 12 may perform various data transmissions with the first computer device 11.

The reinforcement learning model M1 is a machine learning model based on reinforcement learning. Reinforcement learning is an interactive learning method whose learning process will be affected by environmental rewards. For example, in the reinforcement learning model M1, an agent executes an action according to a policy and calculates the value of each policy through a value function. In addition, the agent decides how to adjust the policy according to the state of the environment and the obtained reward of the action. With repeatedly adjusting the policy, the action of the reinforcement learning model M1 will be adapted to the environment.

The supervised learning model M2 is a machine learning model based on supervised learning. Supervised learning uses labeled input data for training/learning, and makes classification or regression repeatedly based on a preset loss function during the training/learning process.

For example, in an embodiment of the present invention, the first computer device 11 may train the reinforcement learning model M1 before storing the reinforcement learning model M1, or may store an initial reinforcement learning model M1 that has been trained. In addition, in an embodiment of the present invention, the first computer device 11 may further train and update the reinforcement learning model M1 after storing the reinforcement learning model M1. For example, in an embodiment of the present invention, the second computer device 12 may train the supervised learning model M2 before storing the supervised learning model M2, or may store an initial supervised learning model M2 that has been trained. In addition, in an embodiment of the present invention, the second computer device 12 may further train and update the supervised learning model M2 after storing the supervised learning model M2. For example, in an embodiment of the present invention, the first computer device 11 and the second computer device 12 may train the reinforcement learning model M1 and the supervised learning model M2 respectively at the same time during the operations of the training system 1. Alternatively, when one of the reinforcement learning model M1 and the supervised learning model M2 meets the conditions for ending the training, the corresponding computer device (i.e., one of the first computer device 11 and the second computer device 12) continues to train the other model.

The input data D1 may be various types of data, such as image data, audio data, text data, or a combination thereof. When the input data D1 comprises image data, the training system 1 may comprise a camera 13 to provide the image data. The camera 13 may provide dynamic images and/or static images.

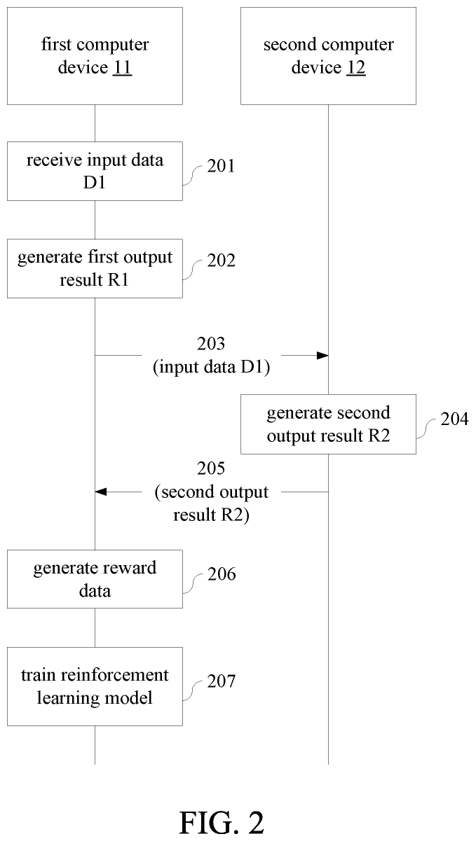

FIG. 2 illustrates operations of the training system of reinforcement learning 1 shown in FIG. 1 according to some embodiments of the present invention. However, the contents shown in FIG. 2 are only for illustrating embodiments of the present invention instead of limiting the scope of the claimed invention. Referring to FIG. 2, training a reinforcement learning model M1 by the training system 1 may comprise operation 201 to operation 207, but the order of the operation 201 to the operation 207 is not limited. In FIG. 2, it is assumed that the input data D1 is the image data provided by the camera 13, as an example.

In the operation 201, the first computer device 11 may receive the input data D1 (i.e., the image data provided by the camera 13).

After completion of the operation 201, the operation 202 may be performed. In the operation 202, the first computer device 11 may feed the input data D1 into the reinforcement learning model M1 to generate a first output result R1. In detail, after the input data D1 is fed into the reinforcement learning model M1, the input data D1 may first enter the flatten layer of the reinforcement learning model M1. In the flatten layer, the format of the input data D1 is converted from a two-dimensional format to a one-dimensional format, so that the input data D1 could be fed into the fully connected layer of the reinforcement learning model M1. When the input data D1 is fed into the fully connected layer of the reinforcement learning model M1, the fully connected layer may gather the filtered data in the high-level layer and generate a classification result (i.e., the first output result R1) based on the features of the data. The first output result R1 may be a numerical value. Taking the input data D1 as the image data corresponding to a scene of a store as an example, the first output result R1 corresponding to the input data D1 may be the number of people appearing in the scene of the store.

In some embodiments, before the first computer device 11 feeds the input data D1 into the reinforcement learning model M1, the first computer device 11 may first preprocess the input data D1, and then feed the preprocessed input data D1 into the reinforcement learning model M1. For example, the preprocessing may be a down-sampling operation performed by the first computer device 11 on the input data D1 to reduce the size of the input data D1 and to ensure that the sizes of all input data D1 are the same. If the size of the input data D1 is reduced before the input data D1 is fed into the reinforcement learning model M1, the calculation amount for analyzing the input data D1 by the reinforcement learning model M1 may be reduced.

After completion of the operation 201, the operation 203 may be performed. In the operation 203, the first computer device 11 may transmit the input data D1 to the second computer device 12. In some embodiments, the first computer device 11 may also preprocess the input data D1 before performing the operation 203 to reduce the size of the input data D1. If the size of the input data D1 is reduced before the operation 203 is performed, the data transmission volume for transmitting the input data D1 may be reduced and the transmission speed thereof may be increased.

In some embodiments, the operation 202 and the operation 203 may be performed simultaneously. In some embodiments, the operation 203 may be performed prior to the operation 202. In some embodiments, the operation 202 may be performed prior to the operation 203.

After completion of the operation 203, the operation 204 may be performed. In the operation 204, the second computer device 12 may feed the input data D1 into the supervised learning model M2 to generate a second output result R2. In detail, after the input data D1 is fed into the supervised learning model M2, the input data D1 may sequentially enter the input layer, the convolution layer, the max pooling layer, the dropout layer, the batch normalization layer, the flatten layer, and the fully connected layer of the supervised learning model M2. The input layer may input the input data D1 and transmit the input data D1 to the convolution layer. The convolution layer may perform convolution operations on the input data D1 and extract the feature matrix of the input data D1 through a feature detector, where a Rectified Linear Unit (ReLU) can be selected for the activation function. The max pooling layer with a good anti-noise function may pick out a maximum value in the feature matrix of the input data D1. For each batch of training data, the dropout layer may dropout half of the feature detectors (i.e., make the numerical value of half of the hidden layer nodes to be zero). The batch normalization layer can learn quickly, does not excessively rely on preset values, and can avoid overfitting. The flatten layer may convert the format of the input data D1 from a two-dimensional format to a one-dimensional format, so that the input data D1 may be fed into the fully connected layer of the supervised learning model M2. The fully connected layer may gather the filtered data in the high-level layer and generate a classification result (i.e., the second output result R2) based on the features of these data.

The definition and expression of the second output result R2 and the first output result R1 are the same. For example, if the first output result R1 corresponding to the input data D1 is the number of people appearing in a scene of a store, the second output result R2 corresponding to the input data D1 will also be the number of people appearing in the scene of the store. In some embodiments, before the second computer device 12 feeds the input data D1 into the supervised learning model M2, the second computer device 12 may first preprocess the input data D1, and then feed the preprocessed input data D1 into the supervised learning model M2. The implementation and the effect of the preprocessing may be the same as or be similar to the preprocessing described in the operation 202, and therefore it will not be described here again.

The supervised learning model M2 may determine whether to update the parameters of the model according to a loss function. The loss function may be expressed as a mean squared error function between a predicted value and an actual value (a labeled value) as follows:

MSE(T)=E((T−Θ))²

where, “MSE(T)” is a mean squared error, “T” is a predicted value, “Θ” is an actual value, and the mean square of the error (difference) between the predicted value and the actual value is the mean squared error. The training of the supervised learning model M2 may be terminated if the mean squared error does not decrease after the supervised learning model M2 has been trained for a preset number of times (e.g., five times).

After completion of the operation 204, the operation 205 may be performed. In the operation 205, the second computer device 12 may transmit the second output result R2 to the first computer device 11.

After completion of the operation 205, the operation 206 may be performed. In the operation 206, the first computer device 11 may generate reward data according to the first output result R1 and the second output result R2. The first computer device 11 may generate the reward data through a reward function. In some embodiments, the reward function may be expressed as follows:

Reward=(−2)×≡C−action|+10

where, “Reward” is the numerical value of the reward data, “C” is the numerical value of the second output result R2, and “action” is the numerical value of the first output result R1.

After completion of the operation 206, the operation 207 may be performed. In the operation 207, the first computer device 11 may train the reinforcement learning model M1 according to the reward data. For example, the first computer device 11 may use the Deep Q-learning Network (DQN) algorithm to train the reinforcement learning model M1, wherein the Q-learning is a common method for estimating the value of the actions. In detail, the first computer device 11 may adjust the policy of the reinforcement learning model M1 according to a value function. In some embodiments, the value function may be expressed as follows:

$${Q}^{′} ( {s}_{t} , {a}_{t} ) = Q ( {s}_{t} , {a}_{t} ) + α \cdot [ R ( {s}_{t} , {a}_{t} ) + γ {max}_{a ∈ A} Q ( {s}_{t + 1} , {a}_{t + 1} ) - Q ( {s}_{t} , {a}_{t} ) ]$$

where, “Q” is the estimated value, “Q′(sₜ, aₜ)” is the updated value function, “Q(sₜ, aₜ)” is the current estimated Q value, and “Q(sₜ₊₁, aₜ₊₁)” is the future estimated Q value, “R (sₜ, aₜ)” is the numerical value of the reward data (i.e., the aforementioned “Reward” parameter), “α” is a learning rate, and “γ” is a decay coefficient. The aforementioned value function is well-known by a person having ordinary skills in the art, and the meaning and source of the symbols therein are the same as those of conventional knowledge. For example, “Q (sₜ, aₜ)”, shown as the first step, represents that the first decision (the current estimated Q value of the first state) made in the first state, and “Q(sₜ₊₁, aₜ₊₁)”, shown as the second step, is the second decision (the future estimated Q value of the second state) made in the second state, and so on.

The reinforcement learning model M1 may generate its action (i.e., generate a recognition result) according to its policy. For example, the policy may be: an exploration policy, an exploitation policy, or an c-greedy policy. The exploration policy may randomly generate an action. The exploitation policy may also be called as a “greedy policy,” which may use all the current Q values to generate an optimal action. The ε-greedy policy is a policy that combines the exploration policy and the exploitation policy.

In some embodiments, the training system 1 may comprise a plurality of first computer devices 11, and each of the plurality of first computer devices 11 is electrically connected to the second computer device 12. In this case, each of the plurality of first computer devices 11 stores a reinforcement learning model M1, and the second computer device 12 stores a supervised learning model M2. Each of the plurality of first computer devices 11 provides its input data D1 to the second computer device 12, and the second computer device 12 provides the corresponding second output result R2 for the reinforcement learning model M1 of the corresponding first computer device 11 according to the received input data D1. Since each first computer device 11 operates independently, when a first computer device 11 needs to stop its operation for retraining, the other first computer devices 11 will not be affected, and the training system 1 does not need to stop all operations either.

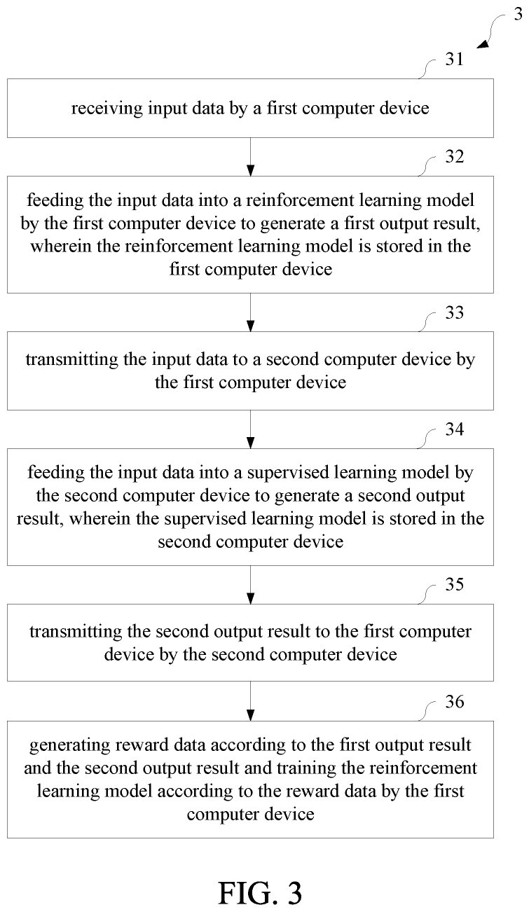

FIG. 3 illustrates a flow of a training method of reinforcement learning according to some embodiments of the present invention. However, the contents shown in FIG. 3 are only for illustrating embodiments of the present invention instead of limiting the scope of the claimed invention.

Referring to FIG. 3, a training method 3 of reinforcement learning may comprise the following steps: receiving input data by a first computer device (labeled as step 31); feeding the input data into a reinforcement learning model by the first computer device to generate a first output result, wherein the reinforcement learning model is stored in the first computer device (labeled as step 32); transmitting the input data to a second computer device by the first computer device (labeled as step 33); feeding the input data into a supervised learning model by the second computer device to generate a second output result, wherein the supervised learning model is stored in the second computer device (labeled as step 34); transmitting the second output result to the first computer device by the second computer device (labeled as step 35); and generating reward data according to the first output result and the second output result and training the reinforcement learning model according to the reward data by the first computer device (labeled as step 36). In the training method 3, a computing power of the second computer device is better than a computing power of the first computer device.

The order of the step 31 to the step 36 shown in FIG. 3 is not limited. In any case where it is still implementable, the order of the step 31 to the step 36 shown in FIG. 3 may be adjusted arbitrarily.

According to some embodiments of the present invention, the input data are image data. In addition to the step 31 to the step 36, the training method 3 may further comprise the following steps: obtaining the image data by the first computer device through a camera; and transmitting the image data to the second computer device by the first computer device.

According to some embodiments of the present invention, in addition to the step 31 to the step 36, the training method 3 may further comprise the following steps: preprocessing the input data by the first computer device before feeding the input data into the reinforcement learning model, and then feeding preprocessed input data into the reinforcement learning model by the first computer device

According to some embodiments of the present invention, in addition to the step 31 to the step 36, the training method 3 may further comprise the following steps: preprocessing the input data by the second computer device before feeding the input data into the supervised learning model, and then feeding preprocessed input data into the supervised learning model by the second computer device, and training the supervised learning model by the second computer device before storing the supervised learning model.

According to some embodiments of the present invention, the first computer device is a terminal device and the second computer device is a cloud device. In addition to the step 31 to the step 36, the training method 3 may further comprise the following step: training and updating the supervised learning model by the second computer device after storing the supervised learning model.

According to the embodiments of the present invention, since the high-efficiency computing may be handled by the second computer device instead of the first computer device, the first computer device may be a relatively low-level device, and the computing power and the computing capacity of the first computer device does not need to be very high (i.e., the first computer device does not have the ability to operate and train a supervised learning model). Therefore, a computer device with low computing power can also take the advantages of the traditional supervised-assisted reinforcement learning. That is, through the second output result generated by the second computer device with the supervised learning model for the reference of the first computer device, the amount and the quality of the reward for reinforcement learning of the first computer device will increase. Moreover, the slow convergence speed caused by the instability of the reward data of traditional reinforcement learning can also be improved (that is, the training efficiency can be increased). In summary, through feeding the input data into the first computer device to generate the first output result, and feeding the input data to the second computer device to generate the second output result, the reinforcement learning model in the embodiments will be trained to be more suitable for practical applications.

Each embodiment of the training method 3 at least corresponds to a certain embodiment of the training system 1. Therefore, even though not all embodiments of the training method 3 are described in detail above, a person having ordinary skill in the art can undoubtedly appreciate the embodiments of the training method 3 that are not described in detail according to the above description for the embodiments of the training method 1.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A training system of reinforcement learning, comprising:
a first computer device, being configured to:
store a reinforcement learning model;
receive input data; and
feed the input data into the reinforcement learning model to generate a first output result; and
a second computer device, being electrically connected to the first computer device and being configured to:
store a supervised learning model;
receive the input data from the first computer device;
feed the input data into the supervised learning model to generate a second output result; and
transmit the second output result to the first computer device;
wherein:
the first computer device is further configured to: generate reward data according to the first output result and the second output result, and train the reinforcement learning model according to the reward data; and
a computing power of the second computer device is better than a computing power of the first computer device.

2. The training system of claim 1, wherein the input data is image data, and the first computer device is further configured to: obtain the image data through a camera.

3. The training system of claim 1, wherein the first computer device is further configured to: preprocess the input data before feeding the input data into the reinforcement learning model, and then feed preprocessed input data into the reinforcement learning model.

4. The training system of claim 1, wherein the second computer device is further configured to:
preprocess the input data before feeding the input data into the supervised learning model, and then feed preprocessed input data into the supervised learning model; and
train the supervised learning model before storing the supervised learning model.

5. The training system of claim 1, wherein the first computer device is a terminal device and the second computer device is a cloud device, and wherein the second computer device is further configured to train and update the supervised learning model after storing the supervised learning model.

6. A training method of reinforcement learning, comprising:
receiving input data by a first computer device;
feeding the input data into a reinforcement learning model by the first computer device to generate a first output result, wherein the reinforcement learning model is stored in the first computer device;
transmitting the input data to a second computer device by the first computer device;
feeding the input data into a supervised learning model by the second computer device to generate a second output result, wherein the supervised learning model is stored in the second computer device;
transmitting the second output result to the first computer device by the second computer device; and
generating reward data according to the first output result and the second output result and training the reinforcement learning model according to the reward data by the first computer device;
wherein a computing power of the second computer device is better than a computing power of the first computer device.

7. The training method of claim 6, wherein the input data is image data, and the training method further comprises:
obtaining the image data by the first computer device through a camera; and
transmitting the image data to the second computer device by the first computer device.

8. The training method of claim 6, further comprising:
preprocessing the input data by the first computer device before feeding the input data into the reinforcement learning model, and then feeding preprocessed input data into the reinforcement learning model by the first computer device.

9. The training method of claim 6, further comprising:
preprocessing the input data by the second computer device before feeding the input data into the supervised learning model, and then feeding preprocessed input data into the supervised learning model by the second computer device; and
training the supervised learning model by the second computer device before storing the supervised learning model.

10. The training method of claim 6, wherein the first computer device is a terminal device and the second computer device is a cloud device, and wherein the training method further comprises: training and updating the supervised learning model by the second computer device after storing the supervised learning model.
